(19) United States
(12) Patent Application Publication
(10) Pub. No.: US 2025/0068475 A1
(43) Pub. Date: Feb. 27, 2025

(54) ACCOUNT VENDING

(71) Applicant: TRANS UNION LLC, Chicago, IL (US)

(72) Inventors: Shantel SMITH, Chicago, IL (US); Naveenkumar Amradi, Chicago, IL (US); Sreedhar Kurra, Chicago, IL (US); Vinothkumar Balaraman, Chicago, IL (US); Sandro Seminara, Chicago, IL (US); Kumail Razvi, Chicago, IL (US)

(73) Assignee: TRANS UNION LLC, Chicago, IL (US)

(21) Appl. No.: 18/456,274

(22) Filed: Aug. 25, 2023

(51) Int. Cl. G06F 9/50

(52) U.S. Cl. CPC G06F 9/5038; G06F 9/5077

(57) ABSTRACT

A computing device may determine a first set of applications that facilitate functions for a requested cloud account. A sequential execution order may be determined for a second set of applications to be executed after a respective set of dependencies for each application of the second set of applications and at least one application of the first set of applications have been executed. A parallel execution order may be determined for remaining applications of the first set of applications that are excluded from the sequential execution order. The first and second sets of applications may be executed according to the sequential and parallel execution orders and a notification may be sent to the user device that facilitates access to the cloud account based on an indication that the first and second sets of applications have been successfully executed.

### BACKGROUND

In public cloud multi-account environments, creating, managing, and synchronizing cloud accounts, access permissions, and configurations for client workflows can be a complex and time-consuming task. Existing solutions do not efficiently manage the deployment of applications and their dependencies across multi-account architecture environments, often leading to inconsistency in user permissions, misconfigurations, and security vulnerabilities. Identifying and resolving issues across multiple accounts or environments is challenging due to the lack of management of the applications and their dependencies.

### BRIEF DESCRIPTION OF THE DRAWINGS

The accompanying drawings are incorporated herein and form a part of the specification.

FIG. 1 shows a block diagram of an example system for account vending, according to some aspects of this disclosure.

FIG. 2 shows a block diagram of an example process for executing applications for account vending, according to some aspects of this disclosure.

FIG. 3 shows a flowchart of an example method for account vending, according to some aspects of this disclosure.

FIG. 4 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method, and/or computer program product embodiments, and/or combinations and sub-combinations thereof, for account vending.

The technical landscape and/or infrastructure of an organization, business, and/or operating entity may incorporate a wide array of applications, services, data sources, servers, resources, and/or the like. Applications in the landscape/infrastructure may include custom-built applications, legacy applications, database applications, cloud-based applications, enterprise-resource-planning applications, and/or the like. The applications in the landscape and/or associated data may be configured with/on different devices (e.g., computing devices, servers, etc.) at different locations (e.g., data centers, etc.), and/or may be accessed via a network (e.g., cloud, Internet, wide-area network, etc.). Additionally, the organization, the business, and/or the operating entity may be in communication with and/or connect to a plurality of third-party systems, applications, services, and/or APIs to access data and incorporate additional functions into their technical landscape/infrastructure.

According to some aspects of this disclosure, the technical landscape and/or infrastructure of an organization, business, and/or operating entity may operate in and/or be supported by a cloud-based computing environment and/or platform including, but not limited to, Amazon Web Services (AWS), Microsoft Azure, Google Cloud Platform (GCP), IBM Cloud, Oracle Cloud Infrastructure (OCI), Alibaba Cloud DigitalOcean, Linode, and/or the like. According to some aspects of this disclosure, the technical landscape and/or infrastructure of an organization, business, and/or operating entity may include an account (e.g., cloud account, project, subscription, etc.) generation and/or vending system. According to some aspects of this disclosure, an account generation and/or vending system may automate the process of generating and provisioning accounts for accessing a variety of services and/or applications. According to some aspects of this disclosure, an account generation and/or vending system may streamline the account creation process, reduce manual work, and improve security by enforcing account creation policies and rules. According to some aspects of this disclosure, an account generation and/or vending system may be implemented using various technologies, such as cloud-based services, APIs, microservices architectures, and/or the like.

For example, a computing device may determine a first set of applications that facilitate functions for a requested cloud account. A sequential execution order may be determined for a second set of applications to be executed after a respective set of dependencies (e.g., infrastructure dependencies, service dependencies, library dependencies, code dependencies, security element, and/or credential-based dependencies, etc.) for each application of the second set of applications and at least one application of the first set of applications have been executed. A parallel execution order may be determined for the remaining applications of the first set of applications that are excluded from the sequential execution order. The first and second sets of applications may be executed according to the sequential and parallel execution orders and a notification may be sent to the user device that facilitates access to the cloud account based on an indication that the first and second sets of applications have been successfully executed.

According to some aspects of this disclosure, system, apparatus, device, method, and/or computer program product embodiments, and/or combinations and sub-combinations thereof, for account vending facilitate the generation, management, and synchronization of cloud accounts and related information (e.g., resources, access permissions, configurations, etc.) while minimizing compute resources. According to some aspects of this disclosure, an account generation and/or vending system may leverage a branch processing module and/or framework to manage the deployment and lifecycle of foundational cloud infrastructure to target accounts. According to some aspects of this disclosure, target accounts may enable users/applications/systems to access and manage resources including, but not limited to, computing power, storage, databases, services, and/or the like. According to some aspects of this disclosure, the account generation and/or vending system may orchestrate the generation of accounts with entity-specific guardrails and network connectivity. According to some aspects of this disclosure, the account generation and/or vending system described herein facilitates “one-click” cloud-based account creation, where account requests are handled expeditiously with minimal complexity. For example, account generation may be initiated responsive to the submission of verified credentials, account functionality detail, and/or the like. According to some aspects of this disclosure, credentials may be verified and/or account functionality detail may be submitted via a interactive user interface, for example, supporting drag-and-drp functionality and/or the like. According to some aspects of this disclosure, the account generation and/or vending system described herein eliminates the need for ad-hoc scripts, pipelines, and engineering runbooks for the generation and/or maintenance of accounts, for example, within a cloud-based platform, and therefore provide advantages and improvements to at least the technological fields of cloud computing, account management, and/or the like. These and other technological advantages are described herein.

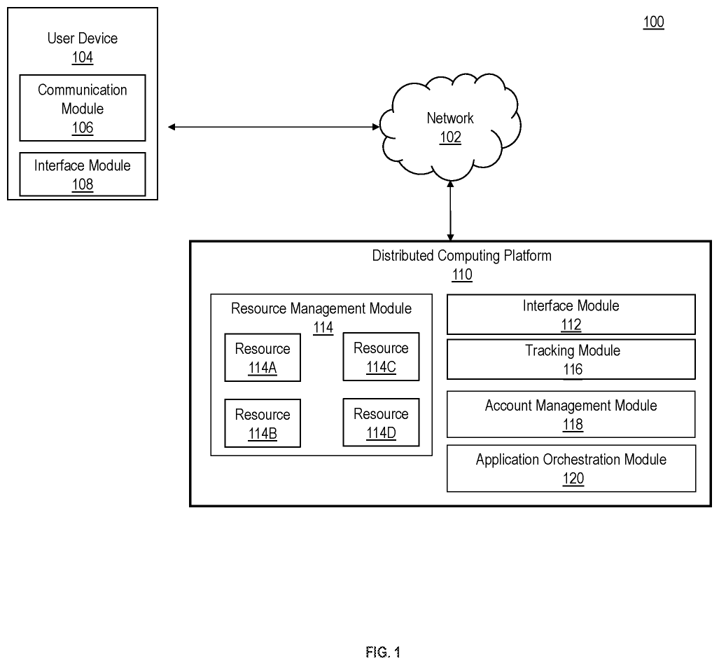

FIG. 1 shows a block diagram of an example system 100 for account vending. System 100 is merely an example of one suitable system environment and is not intended to suggest any limitation as to the scope of use or functionality of aspects described herein. Neither should the system 100 be interpreted as having any dependency or requirement related to any single module/component or combination of modules/components described therein.

According to some aspects of this disclosure, system 100 may include a network 102. According to some aspects of this disclosure, network 102 may include a packet-switched network (e.g., internet protocol-based network), a non-packet switched network (e.g., quadrature amplitude modulation-based network), and/or the like. According to some aspects of this disclosure, network 102 may include network adapters, switches, routers, modems, and the like connected through wireless links (e.g., radiofrequency, satellite) and/or physical links (e.g., fiber optic cable, coaxial cable, Ethernet cable, or a combination thereof). Network 102 may include public networks, private networks, wide area networks (e.g., Internet), local area networks, and/or the like. According to some aspects of this disclosure, network 102 may include a content access network, content distribution network, and/or the like. According to some aspects of this disclosure, network 102 may provide and/or support communication from telephone, cellular, modem, and/or other electronic devices to and throughout the system 100. For example, system 100 may include and support communications between a user device 104 and a distributed computing platform 110 via network 102.

According to some aspects of this disclosure, although shown as a single device, user device 104 may be part of a client and/or user computing system and/or infrastructure. For example, user device 104 may represent a plurality of user devices in communication and/or interoperability within a client and/or user computing system and/or infrastructure. According to some aspects of this disclosure, although user device 104 is shown in FIG. 1, system 100 may be in communication with and/or support any number of user devices and/or client/user computing systems.

According to some aspects of this disclosure, user device 104 may include, for example, a smart device, a mobile device, a laptop, a tablet, a display device, a computing device, or any other device capable of communicating with distributed computing platform 110, and/or any other device/component of system 100. User device 104 may include communication module 106 that facilitates and/or enables communication with network 102 (e.g., devices, components, and/or systems of network 102, etc.), distributed computing platform 110, and/or any other device/component of system 100. For example, communication module 106 may include hardware and/or software to facilitate communication. According to some aspects of this disclosure, communication module 106 may include one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. According to some aspects of this disclosure, communication module 106 may include any hardware and/or software necessary to facilitate communication.

According to some aspects of this disclosure, user device 104 may include an interface module 108. According to some aspects of this disclosure, interface module 108 enables a user to interact with user device 104, network 102, distributed computing platform 110, and/or any other device/component of system 100. Interface module 108 may include any interface for presenting and/or receiving information to/from a user.

According to some aspects of this disclosure, interface module 108 enables a user to view and/or interact with content, applications, web pages, and/or user interfaces. According to some aspects, interface module 108 may include a web browser (e.g., Internet Explorer®, Mozilla Firefox®, Google Chrome®, Safari®, or the like). According to some aspects, interface module 108 may request or query various files from a local source and/or a remote source, such as distributed computing platform 110, and/or any other device/component of system 100. For example, interface module 108 may be used to request the generation of a cloud-based account, access a cloud-based account, manipulate components of a cloud-based account, and/or the like.

According to some aspects, interface module 108 may include one or more input devices and/or components, for example, such as a keyboard, a pointing device (e.g., a computer mouse, remote control), a microphone, a joystick, a tactile input device (e.g., touch screen, gloves, etc.), and/or the like. According to some aspects, interaction with the input devices and/or components may enable a user to interact with a user interface generated and/or displayed by the interface module 108 and/or the like. According to some aspects, interaction with the input devices and/or components may enable a user to request the generation of a cloud-based account, access a cloud-based account, manipulate components of a cloud-based account, and/or the like.

According to some aspects of this disclosure, distributed computing platform 110 may be and/or include a system, compute infrastructure/architecture, and/or software platform configured to access a plurality of software applications, services, and/or data sources. According to some aspects of this disclosure, distributed computing platform 110 may be and/or include, support, and/or facilitate Infrastructure-as-a-Service (IaaS), Platform-as-a-Service (PaaS), Software-as-a-Service (SaaS), cloud-computing platforms (e.g., Amazon Web Services (AWS), Microsoft Azure, Google Cloud Platform (GCP), IBM Cloud, Oracle Cloud Infrastructure (OCI), Alibaba Cloud DigitalOcean, Linode, etc.), and/or the like. According to some aspects of this disclosure, distributed computing platform 110 may be configured to design, maintain, and deploy cloud-based accounts according to disparate software applications, services, and/or data sources. For example, according to some aspects of this disclosure, distributed computing platform 110 may include/incorporate an enterprise service bus (ESB) architecture, a micro-service architecture, a service-oriented architecture (SOA), and/or the like. According to some aspects of this disclosure, distributed computing platform 110 may allow a user to build and deploy integrations that communicate with and/or connect to third-party systems and provide additional functionalities that may be used to further integrate data from a plurality of organizational and/or cloud-based data sources. According to some aspects of this disclosure, distributed computing platform 110 may support and/or facilitate integration flows, APIs, applications, and/or the like that access data, manipulate data, store data, and leverage data from disparate technical resources.

According to some aspects of this disclosure, distributed computing platform 110 may include an interface module 112. According to some aspects of this disclosure, interface module 112 enables a user to interact with distributed computing platform 110, user device 104, network 102, and/or any other device/component of system 100. Interface module 112 may include any interface for presenting and/or receiving information to/from a user. Interface module 112 may be implemented as a web-based application, desktop application, or other suitable interface. According to some aspects of this disclosure, interface module 112 may enable users to interact with tools and/or resources used to generate automated pipelines to test and deploy code changes. For example, interface module 112 may enable users to interact with tools and/or resources used to build and test applications on various computing platforms.

According to some aspects of this disclosure, interface module 112 allows users to interact with an account management module 118, an application orchestration module 120, and/or any other module, device, and/or component distributed computing platform 110 to generate, modify, and delete cloud-based accounts, manage access permissions, and configure and/or manipulate branch configurations for the cloud-based accounts. According to some aspects of this disclosure, branch configurations for the cloud-based accounts may include, but are not limited to, any settings and/or configurations applied to resources (e.g., resource instances 114A-114D, etc.) and/or services for an account and/or related accounts. According to some aspects of this disclosure, branch configurations may include different versions of one or more workflows and/or orchestrated sets of applications, such as within development, staging, and production environments. Each branch might have its specific configurations to reflect its purpose and requirements.

According to some aspects of this disclosure, separate cloud-based accounts or separate resources (e.g., resource instances 114A-114D, etc.) may be associated with different branch configurations. The configurations may define scaling policies, security settings, and/or the like. By generating, supporting, and maintaining different branch configurations in cloud-based accounts, account management module 118 and application orchestration module 120 ensure the appropriate separation of client environments, reduce potential risks, and facilitate the development and deployment process of accounts.

According to some aspects of this disclosure, distributed computing platform 110 may include a resource module 114. Resource module 114 may include a plurality of servers and storage devices configured to provide a plurality of resource instances 114A-114D. According to some aspects of this disclosure, although only four resource instances 114A-114D are shown in FIG. 1 for reference, distributed computing platform 110 may include any number of resource instances 114A-114D. According to some aspects of this disclosure, any of the resource instances 114A-114D may communicate with any other of the resource instances 114A-114D over a virtual network and/or the like provided by distributed computing platform 110.

According to some aspects of this disclosure, resource instances 114A-114D may include a plurality of web and/or cloud-based services that enable users to utilize virtual computers (e.g., instances), run customized applications, and leverage scalable computing capacity.

According to some aspects of this disclosure, resource instances 114A-114D may include a plurality of database instances and/or storage instances provided by a plurality of computing and/or storage devices and/or mediums (e.g., data lakes, data silos, data buckets, virtual storage, remote storage, physical storage devices, relational databases, etc.). According to some aspects of this disclosure, resource instances 114A-114D may include and/or support a plurality of applications operated and/or maintained by entity operators, third-party operators, and/or the like. According to some aspects of this disclosure, resource instances 114A-114D may include managed NoSQL database services, document-oriented databases, and/or the like. According to some aspects of this disclosure, resource instances 114A-114D may support and/or facilitate automatic data partitioning and replication across multiple availability zones, seamless scalability, fast and predictable performance, and flexible data models. According to some aspects of this disclosure, resource instances 114A-114D may support different levels of consistency options to meet the needs of different applications (e.g., web applications, mobile applications, applications that support gaming and/or IoT, etc.).

According to some aspects of this disclosure, resource instances 114A-114D may adhere to any API architectural style, design methodologies, and/or protocols. For example, resource instances 114A-114D may include a Web-API, RESTful API, SOAP API, GraphQL, a remote procedure call (RPC) API, a Java Database Connectivity (JDBC) API, a streaming API, and/or any other type of API.

According to some aspects of this disclosure, resource instances 114A-114C may include and/or support serverless computing services. For example, utilization of resource instances 114A-114D may allow code to be run without provisioning or managing servers such that a user may write and execute code without consideration of infrastructure, scaling, or server maintenance. According to some aspects of this disclosure, any of resource instances 114A-114D enables applications to be built to respond to events generated by any other resource instances 114A-114D. According to some aspects of this disclosure, any of resource instances 114A-114D may be used to generate custom RESTful API endpoints that trigger your user-defined and/or customized functions. According to some aspects of this disclosure, resource instances 114A-114D may include and/or support real-time or batch processing of data, including, but not limited to, operational pattern analysis, data transformation, and/or data validation. According to some aspects of this disclosure, resource instances 114A-114D may be used to run scheduled tasks, such as data backups or periodic data cleanup tasks.

According to some aspects of this disclosure, distributed computing platform 110 may include a tracking module 116. Tracking module 116 may track, log, and/or store a log indicative of operational data and/or operational patterns for user devices (e.g., user device 104, etc.). Operational data and/or operational patterns for user devices may include, but are not limited to information indicative of access requests made to or within distributed computing platform 110, resources (e.g., applications, tools, data, etc.) utilized, and/or accesses by user devices in communication with distributed computing platform 110, inter-resource communications, and/or the like.

For example, according to some aspects of this disclosure, a first application executing on resource instance 114A may request to access information stored on resource instance 114D. To request to access information stored on resource instance 114D, resource instance 114A may call a specific API. When resource instance 114A calls the specific API, tracking module 116 may detect the call and may track, log, and/or store associated information. For example, tracking module 116 may include text information and/or numerical information describing each API call associated with an account. The information associated with a particular API call may include, but is not limited to, an identifier of a user of user device 104, an identifier of user device 104, a role (or application having been assigned a role) that called the API, the API called, the time of the call, the source IP address of the caller, parameters included in the API call, and any responses returned including error messages such as an access denied error.

According to some aspects of this disclosure, as previously described, account management module 118 may provide application deployment and management services within distributed computing platform 110. According to some aspects of this disclosure, account management module 118 may generate, modify, and delete cloud-based accounts and assign appropriate access permissions based on branch configurations. According to some aspects of this disclosure, account management module 118 may include and/or communicate with a configuration repository to retrieve and store accounts and access permission data.

According to some aspects of this disclosure, account management module 118 may facilitate and/or support security, authentication, and/or the like within distributed computing platform 110, for example, with regards to access and/or operation of application orchestration module 120. According to some aspects of this disclosure, account management module 118 may facilitate and/or support security, authentication, and/or the like to ensure that only authorized users and applications can access the application orchestration module 120 and/or any other devices, resources, and/or components of system 100. For example, account management module 118 may use various authentication methods and/or frameworks including, but not limited to, open authorization (OAuth), secure assertion markup language (SAML), lightweight directory access protocol (LDAP), and/or the like.

According to some aspects of this disclosure, application orchestration module 120 may be responsible for maintaining consistency across all branches by synchronizing configurations, accounts, and access permissions. Application orchestration module 120 may communicate with account management module 118 (e.g., the configuration repository, etc.) and each application branch to ensure that all branches have the most up-to-date information.

According to some aspects of this disclosure, application orchestration module 120 may manage the execution of applications across multiple cloud-based accounts and environments. According to some aspects of this disclosure, application orchestration module 120 may ensure consistent deployment of resources and configurations across different accounts while handling application dependencies and/or execution orders.

According to some aspects of this disclosure, application orchestration module 120 may receive information indicative of a plurality of applications to be executed for a requested account and their respective configurations associated with an account from account management module 118. According to some aspects of this disclosure, application orchestration module 120 may include a predictive model that recommends applications to be executed for a requested account. According to some aspects of this disclosure, application orchestration module 120 analyzes historical account configurations, application usage patterns, operational data, operational patterns, and/or other relevant features to make recommendations for applications to be executed for a requested account.

For example, tracking module 116 may provide application orchestration module 120 data indicative of historical account configurations, application usage patterns, operational data, operational patterns, and/or other relevant features (e.g., account types, industry information, scaling/sizing information, etc.). Data indicative of historical account configurations, application usage patterns, operational data, operational patterns, and/or other relevant features may be cleaned and preprocessed to ensure it is in a suitable format for training the predictive model. For example, historical account configurations, application usage patterns, operational data, operational patterns, and/or other relevant features may be represented as normalized numeric features, encoding categorical features, and/or the like.

According to some aspects of this disclosure, application orchestration module 120 may generate relevant features to represent each account and its associated applications. According to some aspects of this disclosure, features may include, but are not limited to, application popularity, frequency of co-occurring applications, application performance metrics, and/or the like. Additionally, according to some aspects of this disclosure, features may include domain-specific and/or behavior-based features related to the accounts, such as industry-specific application usage patterns.

According to some aspects of this disclosure, the predictive model of application orchestration module 120 may be trained on the preprocessed data and generated features. According to some aspects of this disclosure, the predictive model may be trained (e.g., via collaborative filtering, content-based filtering, matrix factorization, deep learning, etc.) to operate as a classification model, a regression model, a recommendation model, and/or the like based on a target domain and/or desired output. According to some aspects of this disclosure, the performance of the predictive model may be using evaluation metrics including, but not limited to, precision, recall, F1-score, mean average precision (MAP), and/or the like. According to some aspects of this disclosure, the predictive model of application orchestration module 120 may be fine-tuned, for example, via adjustment of hyperparameters and/or the like, as needed to improve performance.

According to some aspects of this disclosure, when a new account is requested, the application orchestration module 120 may use the predictive model to generate recommendations for applications to be added to the account based on the account's characteristics and application usage patterns. For example, application orchestration module 120 may use the predictive model's recommendations to determine which applications to add to the requested account, either automatically or by presenting a ranked list of recommended applications to a user (e.g., an account administrator, etc.) for manual selection. According to some aspects of this disclosure, application orchestration module 120 may use the predictive model to provide more targeted and relevant application recommendations for accounts. Accordingly, application orchestration module 120 may improve the efficiency of account setup and increase the likelihood of successful application adoption.

According to some aspects of this disclosure, whether an application has been indicated by account management module 118 or recommended by a predictive model of application orchestration module 120, each application may include and/or be associated with an identifier and a set of dependencies that dictate the order in which they must be executed. According to some aspects of this disclosure, application orchestration module 120 may perform dependency analysis to determine the order in which applications must be executed.

According to some aspects of this disclosure, responsive to a request to generate a account (e.g., a one-click cloud-based account creation request, etc.), application orchestration module 120 may analyze the dependencies among applications and generate a dependency graph. The dependency graph may be used to determine an execution order (e.g., sequential execution order, parallel execution order, etc.) for applications that consider the relationships between the applications.

According to some aspects of this disclosure, based on a dependency graph and/or the like, application orchestration module 120 may schedule the execution of applications for accounts. It determines a sequential execution order for applications with dependencies and schedules independent applications for parallel execution. Independent applications are those with no dependencies or those whose dependencies have already been executed.

According to some aspects of this disclosure, application orchestration module 120 may execute applications in the determined sequential order based on the respective dependencies and execute independent applications in parallel. According to some aspects of this disclosure, the execution status and results of each application may be collected, stored, and/or reported (e.g. reported to a client/user device requesting a account, etc.).

According to some aspects of this disclosure, application orchestration module 120 may receive updates to applications and their configurations. According to some aspects of this disclosure, application orchestration module 120 updates a respective dependency graph according to updates to applications and adjusts the execution schedule for the applications accordingly.

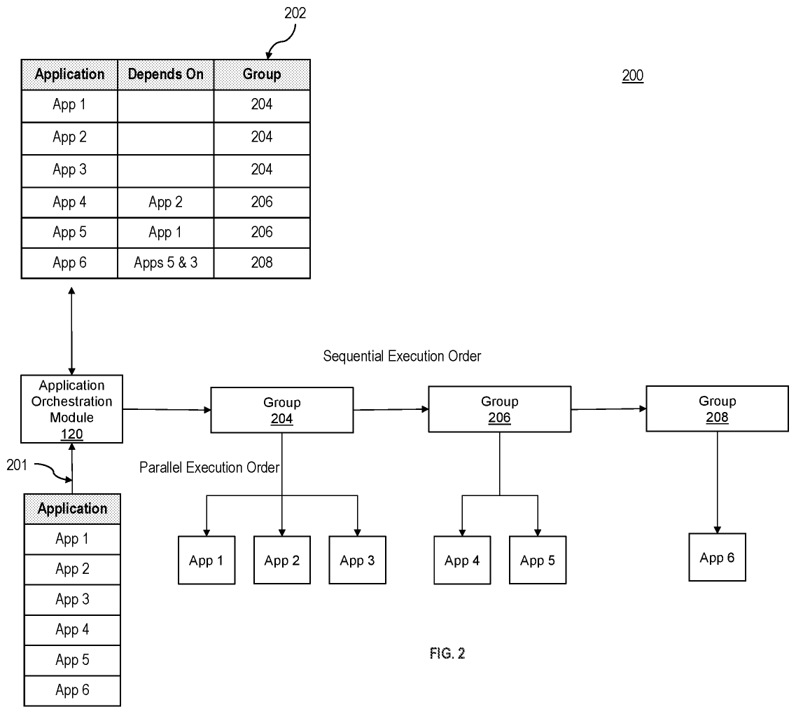

According to some aspects of this disclosure, FIG. 2 shows a block diagram of an example process 200 for executing applications for account vending. At 201, according to some aspects of this disclosure, responsive to a request to generate a account (e.g., a one-click cloud-based account creation request, etc.), account management module 118 may indicate a plurality of applications (e.g., App 1-App 6) to application orchestration module 120. Application orchestration module 120 may analyze the dependencies among the applications (e.g., App 1-App 6) and generate a dependency graph 202. The dependency graph may organize the applications into groups according to inter-dependencies.

For example, for applications Apps 1-6 registered with application orchestration module 120, App 4 may depend on App 2, App 5 may depend on App 1, App 6 may depend on App 5 and App 3. In this scenario, App 1, App 2, and App 3 do not have any dependencies. Since App 1, App 2, and App 3 do not have any dependencies, App 1, App 2, and App 3 may be assigned to Group 204. Since App 4 and App 5 depend on applications in Group 204, App 4 and App 5 may be assigned to Group 206. Since App 6 depends on App 5, which is in Group 206, and App 3, which is in Group 202, App 6 may be assigned to Group 208.

The dependency graph may be used to determine an execution order (e.g., sequential execution order, parallel execution order, etc.) for Apps 1-6 that considers the relationships between the applications. According to some aspects of this disclosure, application orchestration module 120 may execute Group 204, Group 206, and Group 208 in sequence. Group 208 applications may be executed only after all of Group 204 applications are successfully processed. Applications within any group (e.g., Group 204, Group 206, Group 208, etc.) may be executed in parallel.

According to some aspects of this disclosure, application orchestration module 120 provides for centralized management and deployment of applications across different accounts and environments while handling dependencies and execution orders.

Returning to FIG. 1, according to some aspects of this disclosure, application orchestration module 120 may further determine an optimal execution pattern for applications based on an account being generated and historical execution information associated with a plurality of other cloud-based accounts and/or the like. According to some aspects of this disclosure, an optimal execution pattern may minimize compute resource usage for generating cloud accounts. For example, application orchestration module 120 may identify an optimal execution pattern and/or sequence for executing applications that minimize compute resource usage by considering application dependencies, as described, and also considering other various parameters and factors including, but not limited to, resource utilization, workload patterns, auto-scaling, prioritization, cost optimization, containerization, performance metrics, time-based scheduling, right-sizing, and/or the like.

For example, according to some aspects of this disclosure, application orchestration module 120 may monitor and analyze the resource utilization of each application (CPU, memory, storage, network bandwidth) to understand their requirements and efficiently allocate resources. According to some aspects of this disclosure, application orchestration module 120 may analyze the workload patterns of applications (e.g., periodic, bursty, or steady-state) and schedule the execution of applications to maximize resource sharing and minimize idle resources.

According to some aspects of this disclosure, application orchestration module 120 may utilize auto-scaling to minimize compute resource usage for generating cloud accounts. For example, according to some aspects of this disclosure, application orchestration module 120 may implement auto-scaling policies to automatically adjust the number of instances based on an application(s) demand. Auto-scaling policies may help to optimize resource usage and reduce costs.

According to some aspects of this disclosure, application orchestration module 120 may utilize prioritization to minimize compute resource usage for generating cloud accounts. For example, according to some aspects of this disclosure, application orchestration module 120 may assign priorities to applications based on their importance and impact on a business, entity, process, and/or the like. For example, application orchestration module 120 may assign priorities to help in executing high-priority applications first to ensure that critical applications receive adequate resources.

According to some aspects of this disclosure, application orchestration module 120 may utilize cost optimization to minimize compute resource usage for generating cloud accounts. For example, according to some aspects of this disclosure, application orchestration module 120 may analyze the cost of various compute resources (e.g., on-demand, reserved instances, or spot instances) and choose the most cost-effective options without compromising performance.

According to some aspects of this disclosure, application orchestration module 120 may utilize application performance metrics to minimize compute resource usage for generating cloud accounts. For example, according to some aspects of this disclosure, application orchestration module 120 may monitor application performance metrics (e.g., latency, throughput, error rates) and adjust resource allocation to meet desired service levels.

According to some aspects of this disclosure, application orchestration module 120 may utilize containerization to minimize compute resource usage for generating cloud accounts. For example, according to some aspects of this disclosure, application orchestration module 120 may utilize containerization technologies (e.g., Docker, etc.) and orchestration tools (e.g., Kubernetes, etc.) to improve resource utilization, as containers can share resources more efficiently than traditional virtual machines.

According to some aspects of this disclosure, application orchestration module 120 may utilize time-based scheduling to minimize compute resource usage for generating cloud accounts. For example, according to some aspects of this disclosure, application orchestration module 120 may schedule non-critical or batch processing applications during off-peak hours to minimize resource contention and take advantage of lower-cost resources if available (e.g., AWS EC2 Spot Instances).

According to some aspects of this disclosure, application orchestration module 120 may utilize right-sizing to minimize compute resource usage for generating cloud accounts. For example, according to some aspects of this disclosure, application orchestration module 120 may ensure that the chosen instance types or resource configurations for applications are optimal for the application's requirements. According to some aspects of this disclosure, application orchestration module 120 may periodically review and adjust instance types or resource configurations based on changes in application requirements or resource usage patterns.

According to some aspects of this disclosure, once an account has been generated and/or created, application management module 118 may assist in the lifecycle management of core services supporting the application. For example, according to some aspects of this disclosure, application management module 118 may send a notification (e.g., simple notification service (SNS) notification, HTTP/HTTPS notification, short message service (SMS) notification, simple queue service (SQS) notification, etc.) to foundational devices and/or users within distributed computing platform 110 with information related to the account. For example, foundational devices and/or users within distributed computing platform 110 may receive information related to the account to initiate related workflows and/or the like.

According to some aspects of this disclosure, foundational devices and/or users within distributed computing platform 110 may be assigned to manage and/or maintain foundational services and infrastructure within the distributed computing platform 110 ecosystems. For example, foundational devices and/or users within distributed computing platform 110 may be responsible for: ensuring the stability, security, and scalability of services provided via distributed computing platform 110; developing and maintaining core infrastructure components, such as compute services, storage services, and networking services; continuously improving the performance, efficiency, and reliability of services provided via distributed computing platform 110; and collaborating with other foundational devices and/or users to develop and implement new features and improvements within distributed computing platform 110.

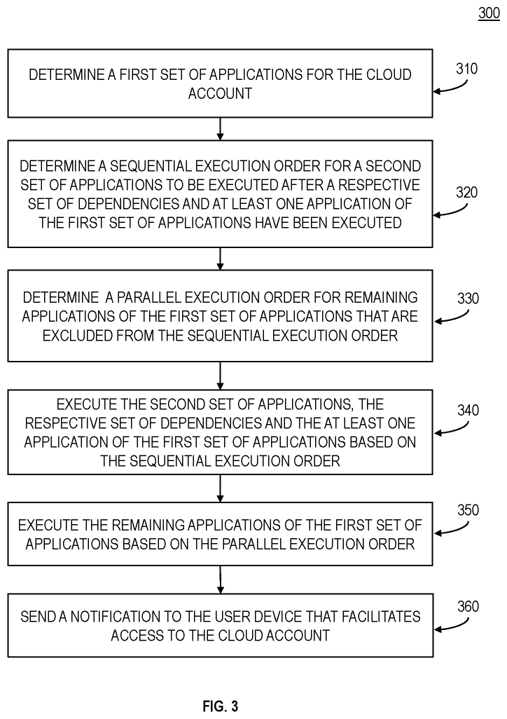

FIG. 3 is a flowchart for a method 300 for account vending, according to some aspects of this disclosure. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIGS. 1-2. However, method 300 is not limited to that example embodiment.

In 310, distributed computing platform 110 determines a first set of applications for the cloud account that each facilitate at least one function indicated by received functionality information. For example, distributed computing platform 110 may determine the first set of applications for the cloud account that each facilitate at least one function indicated by functionality information based on the functionality information being received with a request from a user device to generate a cloud account. For example, a user of the user device may interact with an interactive element of a user interface to send the request to generate the cloud account.

According to some aspects of this disclosure, determining the first set of applications may further include distributed computing platform 110 sending an indication of a recommended application to the user device. For example, distributed computing platform 110 may send the indication of the recommended application to the user device based on an indication of an operational pattern for the user device. For example, the recommended application may be an application that complements, supports, enhances, and/or the like applications and/or actions indicated by the operational pattern. According to some aspects of this disclosure, distributed computing platform 110 may add the recommended application to the first set of applications. For example, distributed computing platform 110 may add the recommended application to the first set of applications based on confirmation information for the recommended application received from the user device.

In 320, distributed computing platform 110 determines a sequential execution order for a second set of applications to be executed after a respective set of dependencies for each application of the second set of applications and at least one application of the first set of applications has been executed. For example, distributed computing platform 110 may determine the sequential execution order for the second set of applications to be executed after the respective set of dependencies and the at least one application of the first set of applications have been executed based on a respective set of dependencies for each application of the second set of applications mapped to the at least one application of the first set of applications.

According to some aspects of this disclosure, determining the sequential execution order may further include distributed computing platform 110 generates a dependency graph that indicates dependency relationships between each application of a second set of applications and the at least one application of the first set of applications. According to some aspects of this disclosure, distributed computing platform 110 may determine the sequential execution order based on the dependency graph.

According to some aspects of this disclosure, determining the sequential execution order may further include distributed computing platform 110 assigning respective priority levels to each application of the second set of applications.

In 330, distributed computing platform 110 determines a parallel execution order for the remaining applications of the first set of applications that are excluded from the sequential execution order.

In 340, distributed computing platform 110 executes the second set of applications after the respective set of dependencies and the at least one application of the first set of applications is executed. For example, distributed computing platform 110 may execute the second set of applications after the respective set of dependencies and the at least one application of the first set of applications is executed based on the sequential execution order.

In 350, distributed computing platform 110 executes the remaining applications of the first set of applications. For example, distributed computing platform 110 may execute the remaining applications of the first set of applications based on the parallel execution order.

In 360, distributed computing platform 110 sends a notification to the user device that facilitates access to the cloud account. For example, distributed computing platform 110 may send the notification to the user device that facilitates access to the cloud account based on an indication that each application of the first set of applications and each application of the second set of applications is executed successfully. According to some aspects of this disclosure, the notification may include, but is not limited to, an access link for accessing the cloud account, a credential(s) (e.g., multi-factor authentication information, single sign-on (SSO) information, etc.) for accessing the cloud account, and/or the like.

According to some aspects of this disclosure, the method 300 may further include distributed computing platform 110 modifying the sequential execution order. For example, distributed computing platform 110 may modify the sequential execution order based on events including, but not limited to, an update to an application of the first set of applications, an update to an application of the second set of applications, and/or the like. According to some aspects of this disclosure, distributed computing platform 110 modifies the parallel execution order. For example, distributed computing platform 110 may modify the parallel execution order based on an execution of the second set of applications according to the modified sequential execution order. According to some aspects of this disclosure, distributed computing platform 110 modifies the cloud account. For example, distributed computing platform 110 may modify the cloud account based on an execution of the first set of applications according to the modified parallel execution order.

According to some aspects of this disclosure, the method 300 may further include distributed computing platform 110 determining an optimal execution pattern for at least one of the first set of applications or the second set of applications. For example, distributed computing platform 110 may determine the optimal execution pattern based on the cloud account and historical execution information associated with a plurality of cloud accounts associated with the first set of applications, the second set of applications, and/or the like. According to some aspects of this disclosure, the optimal execution pattern minimizes compute resource usage for generating cloud accounts.

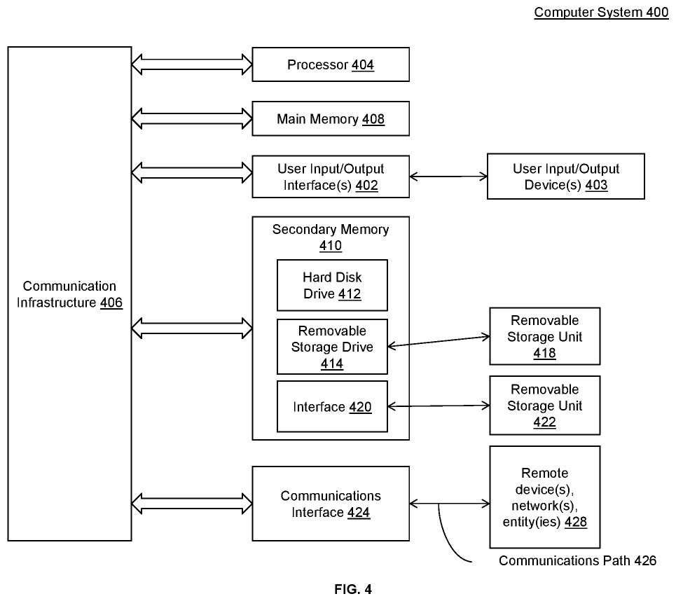

FIG. 4 is an example computer system useful for implementing various embodiments. Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof. According to some aspects of this disclosure, any device/component described herein may be implemented using the computer system 400. According to some aspects, the computer system 400 may be used to implement method 400 and/or any other methods and/or steps described herein.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure or bus 406 through user input/output device(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, a tape backup device, and/or any other storage device/drive.

Removable storage drive 414 may interact with a removable storage unit 418. The removable storage unit 418 may include a computer-usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to the removable storage unit 418.

Secondary memory 410 may include other means, devices, components, instrumentalities, and/or other approaches for allowing computer programs and/or other instructions and/or data to be accessed by computer system 400. Such means, devices, components, instrumentalities, and/or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, and/or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

Additionally and/or alternatively, while this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

One or more parts of the above implementations may include software. Software is a general term whose meaning of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “an aspect,” “aspects,” “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still cooperate or interact with each other.

The breadth and scope of this disclosure should not be limited by any of the above-described exemplary embodiments, but should be defined only in accordance with the following claims and their equivalents.

What is claimed is:

1. A computer-implemented method comprising:
determining, based on functionality information received with a request from a user device to generate a cloud account, a first set of applications for the cloud account that each facilitate at least one function indicated by the functionality information;
determining, based on a respective set of dependencies for each application of a second set of applications mapped to at least one application of the first set of applications, a sequential execution order for the second set of applications to be executed after the respective set of dependencies and the at least one application of the first set of applications have been executed;
determining a parallel execution order for remaining applications of the first set of applications that are excluded from the sequential execution order;
executing, based on the sequential execution order, the second set of applications after the respective set of dependencies and the at least one application of the first set of applications is executed;
executing, based on the parallel execution order, the remaining applications of the first set of applications; and
sending, based on an indication that each application of the first set of applications and each application of the second set of applications is executed successfully, a notification to the user device that facilitates access to the cloud account.

2. The computer-implemented method of claim 1, wherein the determining the sequential execution order further comprises:
generating a dependency graph that indicates dependency relationships between each application of a second set of applications and the at least one application of the first set of applications; and
determining, based on the dependency graph, the sequential execution order.

3. The computer-implemented method of claim 1, wherein the determining the sequential execution order is further based on respective priority levels assigned to each application of the second set of applications.

4. The computer-implemented method of claim 1, further comprising:
modifying, based on an update to at least one of an application of the first set of applications or an application of the second set of applications, the sequential execution order;
modifying, based on an execution of the second set of applications according to the modified sequential execution order, the parallel execution order; and
modifying, based on an execution of the first set of applications according to the modified parallel execution order, the cloud account.

5. The computer-implemented method of claim 1, wherein the notification comprises at least one of: an access link for accessing the cloud account, or a credential for accessing the cloud account.

6. The computer-implemented method of claim 1, further comprising:
determining, based on the cloud account and historical execution information associated with a plurality of cloud accounts associated with at least one of the first set of applications or the second set of applications, an optimal execution pattern for at least one of the first set of applications or the second set of applications, wherein the optimal execution pattern minimizes compute resource usage for generating cloud accounts.

7. The computer-implemented method of claim 1, wherein the determining the first set of applications further comprises:
sending, based on an indication of an operational pattern for the user device, an indication of a recommended application to the user device; and
adding, based on confirmation information for the recommended application received from the user device, the recommended application to the first set of applications.

8. A system comprising:
a memory; and
at least one processor coupled to the memory and configured to perform operations comprising:
determining, based on functionality information received with a request from a user device to generate a cloud account, a first set of applications for the cloud account that each facilitate at least one function indicated by the functionality information;
determining, based on a respective set of dependencies for each application of a second set of applications mapped to at least one application of the first set of applications, a sequential execution order for the second set of applications to be executed after the respective set of dependencies and the at least one application of the first set of applications have been executed;
determining a parallel execution order for remaining applications of the first set of applications that are excluded from the sequential execution order;
executing, based on the sequential execution order, the second set of applications after the respective set of dependencies and the at least one application of the first set of applications is executed;
executing, based on the parallel execution order, the remaining applications of the first set of applications; and
sending, based on an indication that each application of the first set of applications and each application of the second set of applications is executed successfully, a notification to the user device that facilitates access to the cloud account.

9. The system of claim 8, wherein the determining the sequential execution order further comprises:
generating a dependency graph that indicates dependency relationships between each application of a second set of applications and the at least one application of the first set of applications; and
determining, based on the dependency graph, the sequential execution order.

10. The system of claim 8, wherein the determining the sequential execution order is further based on respective priority levels assigned to each application of the second set of applications.

11. The system of claim 8, the operations further comprising:
modifying, based on an update to at least one of an application of the first set of applications or an application of the second set of applications, the sequential execution order;
modifying, based on an execution of the second set of applications according to the modified sequential execution order, the parallel execution order; and
modifying, based on an execution of the first set of applications according to the modified parallel execution order, the cloud account.

12. The system of claim 8, wherein the notification comprises at least one of: an access link for accessing the cloud account, or a credential for accessing the cloud account.

13. The system of claim 8, the operations further comprising:
determining, based on the cloud account and historical execution information associated with a plurality of cloud accounts associated with at least one of the first set of applications or the second set of applications, an optimal execution pattern for at least one of the first set of applications or the second set of applications, wherein the optimal execution pattern minimizes compute resource usage for generating cloud accounts.

14. The system of claim 8, wherein the determining the first set of applications further comprises:
sending, based on an indication of an operational pattern for the user device, an indication of a recommended application to the user device; and
adding, based on confirmation information for the recommended application received from the user device, the recommended application to the first set of applications.

15. A non-transitory computer-readable medium having instructions stored thereon that, when executed by at least one computing device, causes the at least one computing device to perform operations comprising:
determining, based on functionality information received with a request from a user device to generate a cloud account, a first set of applications for the cloud account that each facilitate at least one function indicated by the functionality information;
determining, based on a respective set of dependencies for each application of a second set of applications mapped to at least one application of the first set of applications, a sequential execution order for the second set of applications to be executed after the respective set of dependencies and the at least one application of the first set of applications have been executed;
determining a parallel execution order for remaining applications of the first set of applications that are excluded from the sequential execution order;
executing, based on the sequential execution order, the second set of applications after the respective set of dependencies and the at least one application of the first set of applications is executed;
executing, based on the parallel execution order, the remaining applications of the first set of applications; and
sending, based on an indication that each application of the first set of applications and each application of the second set of applications is executed successfully, a notification to the user device that facilitates access to the cloud account.

16. The non-transitory computer-readable medium of claim 15, wherein the determining the sequential execution order further comprises:
generating a dependency graph that indicates dependency relationships between each application of a second set of applications and the at least one application of the first set of applications; and
determining, based on the dependency graph, the sequential execution order.

17. The non-transitory computer-readable medium of claim 15, wherein the determining the sequential execution order is further based on respective priority levels assigned to each application of the second set of applications.

18. The non-transitory computer-readable medium of claim 15, the operations further comprising:
modifying, based on an update to at least one of an application of the first set of applications or an application of the second set of applications, the sequential execution order;
modifying, based on an execution of the second set of applications according to the modified sequential execution order, the parallel execution order; and
modifying, based on an execution of the first set of applications according to the modified parallel execution order, the cloud account.

19. The non-transitory computer-readable medium of claim 15, wherein the notification comprises at least one of: an access link for accessing the cloud account, or a credential for accessing the cloud account.

20. The non-transitory computer-readable medium of claim 15, the operations further comprising:
determining, based on the cloud account and historical execution information associated with a plurality of cloud accounts associated with at least one of the first set of applications or the second set of applications, an optimal execution pattern for at least one of the first set of applications or the second set of applications, wherein the optimal execution pattern minimizes compute resource usage for generating cloud accounts.
